(19) United States
(12) Patent Application Publication
(10) Pub. No.: US 2016/0352384 A1
(43) Pub. Date: Dec. 1, 2016

(54) MOBILE INFORMATION TERMINAL COVER ADDITIONALLY EQUIPPED WITH PRIVACY PROTECTION FUNCTION

(71) Applicant: HIKARI HAJIME LLC, Tokyo (JP)

(72) Inventor: Koichi AGEISHI, Tokyo (JP)

(21) Appl. No.: 15/234,172

(22) Filed: Aug. 11, 2016

Related U.S. Application Data
(63) Continuation of application No. PCT/JP2015/054507, filed on Feb. 12, 2015.

(30) Foreign Application Priority Data
Feb. 14, 2014 (JP) 2014-040920

(51) Int. Cl. H04B 1/3888

(52) U.S. Cl. CPC H04B 1/3888; H04M 1/0264

(57) ABSTRACT

A mobile information terminal cover includes a camera lens shielding cover and a microphone for voice speech shielding cover of a movable type in a camera lens portion and a microphone for voice speech portion respectively, which are built in mobile information terminals such as smartphones. It becomes possible to prevent photographing with the camera unintended by a user himself or herself or the leakage of ambient voices by storing the movable type shielding cover, while the camera is being used or during voice speech, and by covering again the camera lens section or the microphone for voice speech section with the shielding cover after the use of the camera or voice speech.

### CROSS-REFERENCE TO RELATED APPLICATIONS

This application is a continuation application of International Patent Application No. PCT/JP2015/054507 filed on Feb. 12, 2015, which claims priority to Japanese Patent Application No. 2014-040920 filed on Feb. 14, 2014, the entire contents of which are incorporated by reference.

### TECHNICAL FIELD

The present invention relates to a mobile information terminal cover that can be used for mobile information terminals such as smartphones while paying attention to privacy protection.

### BACKGROUND ART

Conventionally, a cover that covers a camera lens with a sliding plate, a cover that protects a mobile information terminal main body from water submergence, and the like have been proposed, as a mobile information terminal cover.

### CITATION LIST

Patent Literature 1: JP 3173514

Patent Literature 2: WO2014/019030

In recent years, the leakage of information data possessed or preserved by companies or individuals, in particular, caused by computer viruses, has become a serious problem in the modern society where the internet constitutes major social infrastructure. The current state of affairs is that computer viruses, which have been taking targeted attacks against personal computers possessed by companies or individuals to steal information therefrom, are now turning their fire on privately owned mobile information terminals such as smartphones having performance comparable with that of the personal computers. There is a strong tendency to carry familiar mobile information terminals such as smartphones all the time with him or herself, in other words one could say that they are almost a bundle of personal privacies. Therefore, the prevention of information leakage from these devices may well be said to be a pressing issue.

Since it is anticipated that targeted attacks against personal mobile information terminals by malicious computer viruses will be directed at not only the theft of personal information saved in a device main body, but also at operation of a camera or an operation of a microphone for voice speech built in the device, it is desirable to take measures in order to minimize damages even if operations unintended by an owner should be forced to occur. The present invention allows movable type shielding covers to be provided on the camera lens corresponding section and the microphone for voice speech corresponding section of the mobile information terminal cover, respectively, in order to prevent damage caused by operations unintended by an owner as described above.

### SUMMARY OF INVENTION

According to one or more embodiments of the present invention, providing the camera lens and microphone for voice speech corresponding sections with movable type shielding covers enables minimizing damage caused by malicious computer viruses to operations of the mobile information terminal unintended by an owner.

### BRIEF DESCRIPTION OF DRAWINGS

FIG. 1 is a perspective view of a mobile information terminal cover in a state in which a camera lens and a microphone are not shielded by storing movable type shielding covers for camera lens and microphone portions according to one or more embodiments of the claimed invention.

FIG. 2 is a perspective view of a mobile information terminal cover in a state in which a camera lens and a microphone are shielded by drawing out movable type shielding covers for camera lens and microphone portions according to one or more embodiments of the claimed invention.

### DESCRIPTION OF EMBODIMENTS

To realize such states by minimal operations, an attempt to provide slidable type shielding covers on camera lens and microphone for voice speech corresponding sections of a mobile information terminal is proposed, as one proposal. Even if other methods than that were employed, we do not care about its shape as long as damage caused by unintentional operation can be minimized by shielding the camera lens and microphone portions.

### EXAMPLE 1

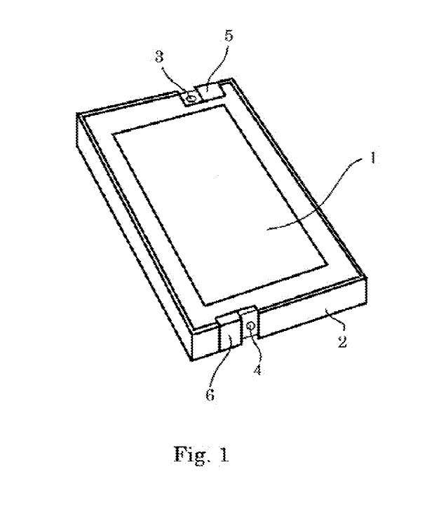

FIG. 1 is a perspective view in a usage state in which a cover 2 is mounted on a mobile information terminal 1, and when photographing with a camera or during voice speech, shielding covers 5, 6 for a camera lens 3 and a microphone for voice speech 4 corresponding sections are stored.

### EXAMPLE 2

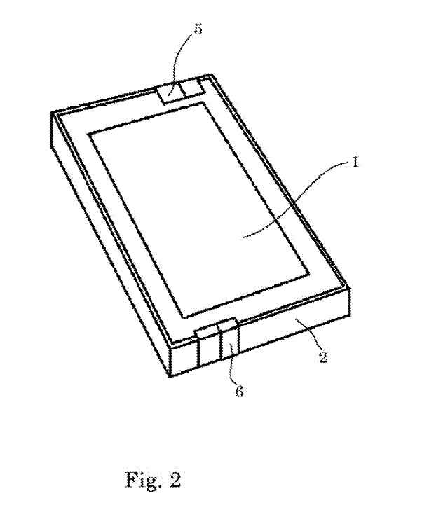

FIG. 2 is a perspective view in a state in which the cover 2 is mounted on the mobile information terminal 1, and it is ready to minimize damage that may be caused by unintentional operation of the camera and the microphone, by pulling out the shielding covers 5, 6 for the camera lens 3 and the microphone for voice speech 4 corresponding sections, and shielding the camera lens and the microphone for voice speech.

While the invention has been described with respect to a limited number of embodiments, those skilled in the art, having benefit of this disclosure, will appreciate that other embodiments can be devised which do not depart from the scope of the invention as disclosed herein.

### DESCRIPTION OF REFERENCE NUMERALS

1 mobile information terminal
2 cover mounted on mobile information terminal
3 camera lens built in mobile information terminal
4 microphone for voice speech built in mobile information terminal
5 shielding cover for camera lens corresponding section
6 shielding cover for microphone for voice speech corresponding section

1. (canceled)

2. A terminal protective cover for a mobile information terminal,
the terminal protective cover comprising:
a movable shielding member configured to move to shield a camera lens built in the mobile information terminal; and
a slidable shielding member configured to slide to shield a microphone for voice speech built in the mobile information terminal.
